(19) United States
(12) Patent Application Publication
(10) Pub. No.: US 2001/0034769 A1
(43) Pub. Date: Oct. 25, 2001

(54) System and method of communicating temporally displaced electronic messages

(76) Inventor: Rodger H. Rast, Rancho Cordova, CA (US)

Correspondence Address: Rastar Corporation, Suite L, 11292 Coloma Rd., Gold River, CA, 95670, US

(21) Appl. No.: 09/800,083

(22) Filed: Mar. 5, 2001

Related U.S. Application Data
(60) Provisional application No. 60/186,978, filed on Mar. 6, 2000.

(51) Int. Cl. G06F 15/16

(52) U.S. Cl. 709/206; 709/207; 709/245

(57) ABSTRACT

A system and method for sending temporally displaced electronic messages over a network from a sender to a recipient. The sending system is configured to allow the user to encode a temporal specifier into an electronic message to be sent over the network to a recipient at a destination address on the network. The electronic message is received over the network by a retention system which decodes the temporal specifier and stores the electronic message, sending to the destination in accord with the temporal specifier. In addition, the inventive teachings provide for the integration of additional content with the electronic messages and the use of cross-media communication of messages exemplified for escalating message priority.

### CROSS-REFERENCE TO RELATED APPLICATIONS

This application claims priority from U.S. provisional application Ser. No. 60/186,978 filed on Mar. 6, 2000.

### BACKGROUND OF THE INVENTION

1. Field of the Invention

This invention pertains generally to the transmission of electronic mail messages and more particularly to a system and method for sending electronic mail messages with a temporal selector that directs delivery of the email after the preselected delay or at the preselected time, while further capable of encoding additional elements and message escalation.

2. Description of the Background Art

Various mechanisms exist for communicating electronic messages, hereafter referred to as “email”, to a recipient over a network. In general, the sending of email involves composing, or otherwise creating or collecting content, which is then addressed to a recipient and sent, typically over the Internet. During the sending of an email, a connection is established to the internet and the email is typically sent from the system on which it was composed to the ISP (Internet Service Provider) of the sender, from which it is directed through the internet to the recipients listed within the email via their ISPs. The destination ISPs receive the email and a mail receipt flag is set to a recipient. Each recipient can collect the email through their mail server which is often comprises an SMTP host.

Email messages can be sent to various recipients including a primary recipient, a list of recipients, “carbon copy” (cc:) or secondary recipients, and even “blind carbon copy” (bcc:) recipients which are not identified in the header. Email sending is generally associated with email composition programs which are typically packaged with internet browsers. However, a vast number of conventional programs are also configured with email composition and sending capability, a few examples being: contact management programs, accounting programs, ERP programs, EDI systems, and internet enabled appliances. The use of email is an important communication media and it is becoming ubiquitous with computer usage. Electronic mail is being additionally utilized to incorporate non-textual items embedded within the email, such as HTML. In addition, forms of electronic data interchange (EDI) are being performed, especially within the business-to-business internet sector (B-B), which utilizes embedded messaging for communicating transactions by utilizing embedded control languages, for example the inclusion of XML statements. One advantage of email as a medium for sending information is the ease and speed with which it can be performed. The email can be sent from many applications without ever leaving the program environment, or the need to access the world wide web and log on to a website. In communicating by email, the user need only select the send option, or otherwise select a pull-down menu to create and send an email. The system can establish the connection and send the email with minimum effort on the part of the sender.

The arrival of an email message is determined by the time it is sent and the delays encountered along the network routing path. Numerous instances arise, however, in which a user desires to compose a message at a given first date and time, for delivery at a given specified second date and time. One example of this is when a user wishes to assure that a timely greeting or reminder is sent. Numerous programs, such as contact managers and schedulers provide the capability to set a reminder. A user can write an email and save it along with a time reminder. Upon receiving the reminder the user can send the email. However, the user is required to be on the system to receive the reminder, and must afterward select the composed email, establish a network connection, and send the email. Certain high-end email composition programs provide users with a plethora of sending options, at least one such program consolidates the reminder into the email so that the user is not required to manually select the email. The email in this instance can be composed and a reminder, or send time, set for the future from the application. Unfortunately, it is necessary that the system on which the user composed the email be in operation, the application be running, and the system connected with the network at the time the desired delivery time arrives, since the message is not sent by the application until the specified time arrives. Neither of these solutions is amenable to a user whose system is not always running or to a user with a dial-up connection which is not always connected.

Web sites initially provided only content, however, they now in many cases support content generation by a user. One type of content generation web site allows users to create greeting cards which are emailed from the site (as HTML, or a link back to the originating web site) to users at a specified time. Typically, a user wishing to send a card or reminder using the site connects to the internet, finds the web site of the content creation site, waits for the site to load (which can be very time consuming as such sites often boast numerous animated graphics, sounds, and advertising), the user logs in with their name and optionally enters a password and/or other information (which can be mined and sold profitably by the site), navigates to the area to create the content, determines how to use the system for creating content, then finally the user can create the content and specify when it is to be delivered. Even though the sender is familiar with creating content on their own machine, they must additionally learn how to use the web site for creating content. The web server hosting the site emails the message at the appropriate time. A recipient of such a message is often sent a notification that an email exists and they too are often required to log onto the web site so that they may view the many advertisements on their way to see the card created for them. This form of specified time delivery requires that the sender, and often both sender and receiver, spend time logging into and traversing a web site in order to create the content.

As can be seen, therefore, a need exists for the development of a mechanism to simplify the delivery of emails at a predetermined time. The system and method for sending temporally displaced email messages in accordance with the present invention satisfies that need, as well as others, and overcomes deficiencies in previously known techniques.

### BRIEF SUMMARY OF THE INVENTION

The present invention is a system and method for sending email messages which are to be delivered at a selected time, and thereby temporally displaced from the time at which they were created and sent by the sender. Messages are addressed and a delivery date set whereupon the email is sent on the network. A node or ISP mail server on the network receives the email, extracts the date and recipient information and retains the message, thereafter delivering it according to the predetermined time. The sender can compose the email from any email composition package and need not log onto a web site or be connected to the internet when the message is sent at the selected time.

An email may be composed or collected (as files or attachments) conventionally, yet the invention allows a specified delivery time to be selected by the user and included within the email for further processing. A network element then retains the message until the specified delivery time arrives at which time it passes the message along to the recipient. It is anticipated that a portion of specified delivery email users will utilize the system to remind themselves of upcoming actions or events, as they can send the email while on any computer system which will be connecting to the internet prior to the date of the reminder. For example to remind them of deadlines on which to send quarterly tax payments, or to place an order, along with other forms of reminders. This is especially useful for computer users that travel or use various computer systems. In addition, use of the system can facilitate the generation of reminder messages from businesses and various institutions that would benefit from providing reminders. A number of mechanisms will be described for retaining email until the delivery time and for the encoding of delivery time within the email.

Characterized by retention location, the following exemplify alternatives for message retention: at sender ISP (or mail server), at recipient ISP (or mail server), and at a separate node. The use of each retention location has benefits and detractors to its use. Using sender ISP retention, the sender's ISP, upon reading the date/time delivery coordinate, (temporal displacement parameter), in the message, stores the message until the appropriate send time. Retention within the recipient's ISP is a similar storage form for holding the message locally pending delivery time. It will be appreciated that corporate users often have their own mail server with an internet connection, wherein an application, or routine within an application, according to the present invention provides for the retention of messages prior to sending them on to the recipient according to the user selected temporal parameter. In a separate node retention embodiment the node need not be associated directly with the sender or receiver, it may be a separate node in the network acting as an intermediary to which the email has been sent for retention and resending at the correct time. It should be appreciated that in separate node retention, an additional address parameter is required to first direct the email to the separate node which provides the intermediary, retention, function.

Temporally displaced electronic mail according to the present invention can employ a variety of mechanisms for containing the specified delivery time and addressing for the processing of the timed delivery emails. The following section describes, by way of example and not of limitation, various encoding methods whose use thereof should be recognized in the subsequent detailed descriptions of the embodiments. The recipient address can be encoded in a number of ways, which include, but are not limited to the following:

“TO” address escalation—the email is addressed in the “TO” field to an intermediary address which performs retention of the email. Addresses of recipients and copy destinations are bumped down into the lesser destination fields. Upon resending by the intermediary the intermediary “TO” field is loaded from the lesser destination fields, and so forth.

“TO” field mapping—additional email fields are used for retaining the addresses and are mapped to the “TO” field after the intermediary (or ISP) resends the email.

“TO” from message body mapping—address fields are encoded within the body of the message. This has the added advantage of allowing group list encoding without the need of special support from the mail composition program, and without actually resending the same message numerous times. The intermediary (or ISP) receives the single message and strips the addressing from the message body and sends a separate email to each recipient.

The specified time for delivery can also be encoded in a variety of ways which include, but are not limited to:

“TO” with embedded time encoding—a date/time coordinate is embedded within the “TO” field of the address. Any time coding format capable of being translated to a delivery date can be encoded, such as a date, a date and time, a time by itself, a delay value, or indirect values such as a holiday which translates to a given time coordinate. In this case, the value is entered within the “TO” address string in a manner allowing it to be generally distinguishable from the actual address.

Field time encoding—a date/time coordinate can be encoded into fields other than the “TO” field or left in its entirety within one of these fields.

Message body time encoding—date/time coordinate placed in the message body. The date/time in this case is preferably at a fixed location within the message, such as at the top, and contains a delimiting string, such as “Send date =”.

As can be seen numerous encoding schemes exist for both recipient encoding and date/time encoding, the examples given can further be mixed and matched and alternative schemes can be easily derived by one of ordinary skill in the art. System implementation can be augmented by integration into an email composition program or other application software which is configured for use with the specified delivery time mechanism of the invention, examples of which are described.

In addition, extensions of the specified time delivery method and system are described, examples of which include the delivery of email to group lists at specified times, the deletion or modification of pending emails, sending of enhanced email, and the automation of reminder generation based on the selected delivery email in concert with various communications media.

An object of the invention is to provide for the delivery of email messages at a specified time.

Another object of the invention is to provide time delivered emails without the necessity of accessing a web site for composing the message.

Another object of the invention is to deliver the composed emails at a selected time without the necessity of having the system on which the emails were composed either running or connected to a network, such that the sender may send the email when connected and subsequently need not concern themselves, knowing that the message will be delivered at the correct time, regardless of the state of their system.

Another object of the invention is to provide a system for the timed delivery of electronic messages that can be implemented as software for integration with existing internet hardware.

Another object of the invention is to provide a system for the timed delivery of electronic messages which is adaptable to different patterns of use and features.

Another object of the invention is to provide a system of timed delivery compatible with group lists.

Another object of the invention is to provide a system of timed delivery that may be implemented with or without cooperation of the email composition program.

Another object of the invention is to provide a system of timed delivery that may be implemented with or without cooperation of the sender's ISP or recipient's ISP.

Another object of the invention is to provide a system of enhanced email delivery wherein multimedia and other formatting may be added from an ISP or intermediary site according to embedded email controls.

Another object of the invention is to provide a system of timed delivery that coordinates communication media which include FAXes, pages, telephones and other media.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a schematic diagram of a network of interconnecting computer systems and servers upon which specified time email delivery according to an embodiment of the present invention have been implemented.

FIG. 2 is a flowchart of method steps according to an embodiment of the present invention showing the process from email composition to delivery at the selected time.

FIG. 3 is a simplified flowchart of date code extraction from within the “TO” field by ISP server software.

FIG. 4 is a schematic of a user to ISP connection showing a user record association with a pending email list for that user.

FIG. 5 is a schematic of a network with interconnecting computers wherein retention of scheduled delivery emails is performed on a node within the network according to an embodiment of the present invention.

FIG. 6 is a schematic of a network with interconnecting computers wherein retention of scheduled delivery emails is performed by the destination ISP prior to being sent to the recipient according to an embodiment of the present invention.

FIG. 7 is a schematic of a network with interconnecting resources showing retention of pending delivery email and the generation of reminder messages based on the temporally displaced email over alternate communications media.

### DETAILED DESCRIPTION OF THE INVENTION

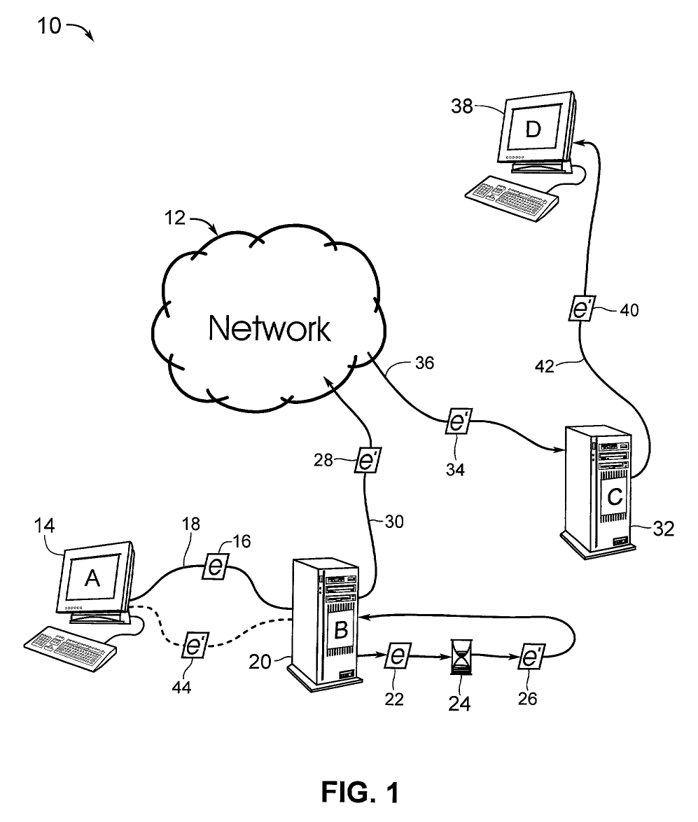

Referring more specifically to the drawings the present invention is embodied, for illustrative purposes, in the apparatus generally shown in FIG. 1 through FIG. 7. It will be appreciated that the system and method may vary as to configuration and as to details of the parts and steps without departing from the basic concepts and methods as disclosed herein.

FIG. 1 illustrates a network with attached computers and servers 10. The network 12 may comprise a network of any size, from a corporate intranet to the Internet (world wide web), which is capable of delivering electronic mail, such as by PPP protocols. By way of example, a series of computers “A” 14, “B” 20, “C” 32, and “D” 38 are shown with a network 12. Programmed instructions executed within each system facilitate communication over the network and the execution of local programs. It will be appreciated that nodes “A” 14, and “D” 38 are configured to access electronic mail to/from the Internet through a mail server, typically an ISP or corporate mail server.

Within this embodiment, the ISP receives the email on the connection to the ISP, prior to it being sent over the network, and no intermediaries (added service nodes) are required for delaying the message as sent to the actual recipient address, or addresses. The specified delivery time within this embodiment is considered to be encoded within the “TO address”. The temporal displacement, however, may be encoded in a wide variety of way, for example placed within other fields, such as the “cc:” or “bcc:” fields, or incorporated into other areas. This in-line encoding of the temporal parameter provides a quick and easy mechanism for the delivery time to be specified separately for each address, if desired. The encoding of the address can be encoded in a variety of ways depending on the composition program being used. For example an address such as “BobQPublic@hello.com” may be encoded with a time delay of 1 week as “BobQPublic:delay1week@hello.com”, whereas delivery on a calendar day could be encoded as “BobQPublic:090200@hello.com” or “BobQPublic:02Sept2000@hello.com”. Alternatively the selected delivery date can be inserted within any existing or added field of the email, for example the first line of the email could specify “Deliver on 090202”. It will be recognized that the date can be encoded in a wide variety of formats which specify the approximate time of delivery to the recipient in various ways. Furthermore, the temporal parameter may comprise fixed dates without a time specification, date and time specifiers, delivery times specified in relation to a known events, and so forth.

The user composes the email on system “A” 14, sets a delivery time within the address field, and sends the email “e” 16, via a connection 18 (typically a dial-up connection) which is picked up by server 20, system “B”, of their ISP. The ISP's server 20 in this instance contains software according to the invention which takes note of the delivery time encoding, and retains the email “e” 22 on one of its mass storage devices for a period of time 24.

In the descriptions which follow, the specified delivery emails are retrieved from storage and sent at the time specified by the sender, and therefore will be received later than the specified time by an interval associated largely with the delay across the network at the time of sending and along the path provided. However network delay patterns can be identified within the specified delivery email retention nodes such that messages from the queue are retrieved prior to the specified delivery time and a calculation applied relating to the destination address and the current delay and loading, so that a more accurate send time is determined and the email is held until this pre-specified time at which it is sent. Arrival to the recipient can thereby be determined to a higher accuracy. Email messages that specify a day and not specific time would not generally warrant the added calculation. It is to be understood in the following discussions that pre-selected time retrieval and sending can be performed within any embodiment of the temporally displaced email system.

A simple embodiment for selected time delivery according to the invention is shown in FIG. 1 and employs a server associated with the sender, typically an ISP, to send the email at the selected time. The ISP maintains a list of selected delivery email messages that have yet to be delivered. Preferably, the list is organized as a chronologically ordered list of retained emails, such that the ISP need only periodically check the top of the list, such as every five minutes. Upon matching up the current system time with an email message in the list, the email is retrieved from the mass storage device and sent. The email 22, as “e” is thus delayed 24 within ISP 20 and after being reformatted and delayed, it is ready as “e′” 26 to be sent on to the recipient. The ordered list of email messages to be delivered, preferably contains at least the fields of delivery date and time, and a pointer to the disk file, or files corresponding to the email message. Server 20 therefore sends email message 28, as “e ” over the ISP connection 30 into the network 12. The ISP of the intended recipient 32, shown as “C” receives the email 34, as “e′” over the network connection 36. A recipient at a computer 38, shown as “D”, upon accessing their ISP and being notified that they have mail, chooses to download their email, causing email 40 as “e′” to be sent over connection 42 to the recipient. The recipient in this case receives the email when logged onto the network at a time equal to the selected delivery date, plus the network delay between ISPs, plus the overhead of the ISP software, plus the delay from when the message arrived and was retrieved. A feature allowing the sender to edit the pending delivery email 44 can be provided at the discretion of the ISP. The embodiment described and illustrated in FIG. 1 provides retention of the email message by the sender's ISP until the delivery time, whereupon it is sent over the network to the recipient. It should be recognized that various entities and hardware implementations can replace the server described at the sender's ISP without departing from this embodiment. Furthermore the email sent by the sender may be retained at different locations along the path from sender to receiver. In general, using an intermediary requires that the email message be sent to the intermediary yet still be encoded with the recipient address information.

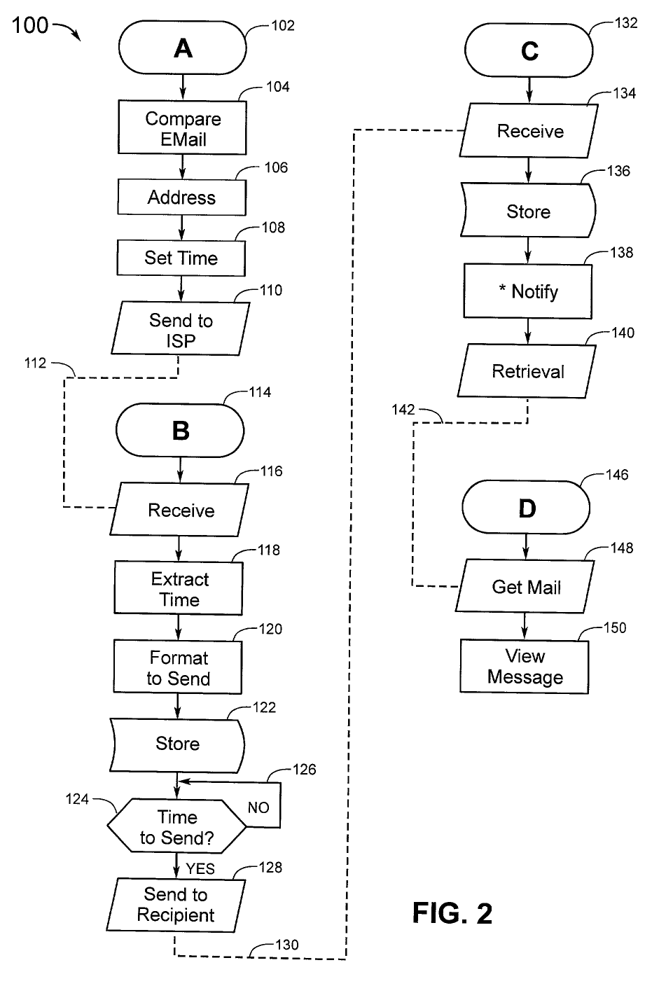

The process according to the embodiment of FIG. 1 is represented by way of example in the flowchart 100 of FIG. 2. It should be appreciated that, as in any software process the description of steps can be varied and reordered with innumerable variation without departing from the inventive principles disclosed. An application is running at block “A” 102 on which an email message is created at block 104 (composed/collected/copied, etc). The email is addressed to a recipient at block 106, preferably in the conventional manner, as this embodiment describes sender ISP retention that does not require an additional intermediate recipient address. The time is set on the email at block 108, preferably by encoding a time specifier within the “TO” address itself, as this provides a simple means of time encoding. After composition and date specification, the email is sent at block 110 off to the sender's ISP at block 112.

A server within the sender's ISP “B” at block 114, receives the email at block 116 from the sender which is to be sent to the specified recipient. The programming in the server being compatible with the present invention, finds the date/time specifier within the “TO” address field and extracts it at block 118. The email is then formatted at block 120 and stored within the system associated with the ISP at block 122. Periodically the pending send times are checked at block 124, periodic checking continues at block 126 until a retained email has a send time in accord with the present date at which time the email is retrieved from storage, had its date/time coordinate stripped (if not already performed) and sent to the recipient at block 130.

The recipient's ISP on server “C” at block 132 receives the message at block 134. The recipient ISP is given as the domain name, for example the “hello.com” in the address “BobQPublic:02Sept2000@hello.com”. The ISP generally stores the message at block 136 (although this can vary depending on messaging protocol) until the recipient asks to retrieve the message. The recipient is notified at block 138 and opts to retrieve the message at block 140.

The recipient being connected on system “D” at block 146 to their ISP receives the message at block 148 into their mail viewing system at approximately the time specified by the original sender and the message is displayed at block 150.

The encoding of a specified send date within an email message, and optionally the encoding of a recipient address for an intermediary retention node, is easily understood as characters inserted by the user or alternately software, such as a composition program, under user control. The extraction of the encoded data is only slightly more complicated. Server software can operate using any form of programming such as Java, Basic, C or other programming environments. All of these programming languages are adept at character string searching and manipulation and substitution so that the extraction operation can be readily performed within the program, or application.

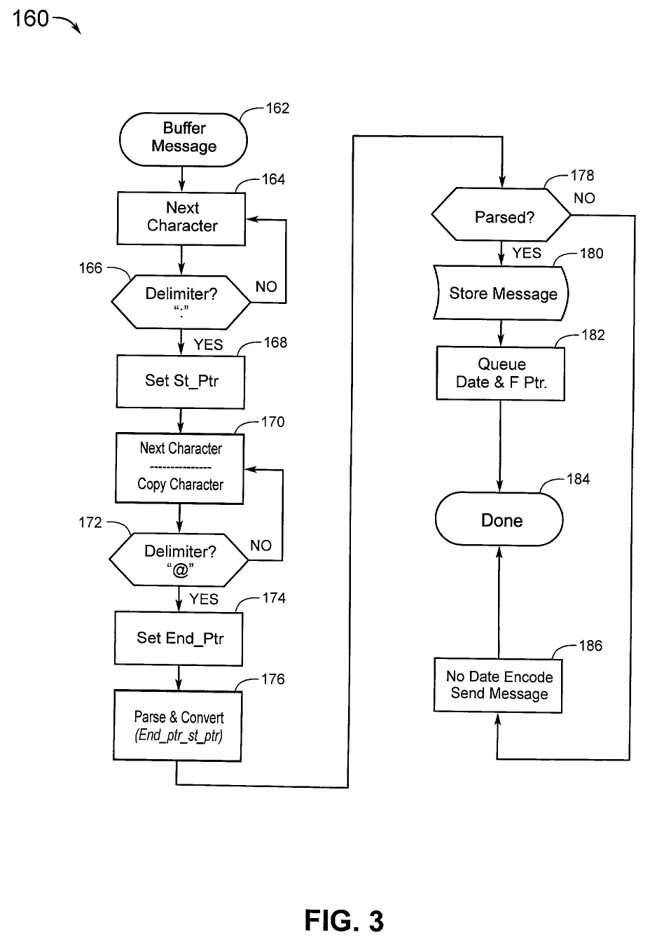

FIG. 3 illustrates a generalized set of program steps at block 160 for extracting an example of a date string “092400” embedded with a delimiter at the end of a user address “JohnQP@Anytown.com” within the “TO” field to form “JohnQP:092400@Anytown.com”. The email message is received and the “TO” field loaded into a buffer at block 162, character mode operations commence with move to next character (first char.) at block 164. The string is scanned until a delimiter, (such as by characters, structures, or uses) is found at block 166, or the end of string is found and operation is then considered complete. In the aforementioned example, the symbol “:” is utilized. A starting string pointer at block 168 is set at start of prospective date section, then a move to next character which is copied at block 170 into a second small string. Characters are copied until the second delimiter ( in this example “@”) is found at block 172. Another pointer is set at block 174 at the end (for optional removal operation) and the substring is parsed for type of embedded date and converted to a system date format at block 176. If the substring was parsed at block 178, then it was a valid date encoding, therefore the associated email message is stored as a file at block 180 and the date and file pointer are queued up 182 for periodic checking and the extract process is complete at block 184. If the date could not be parsed at block 186, then it was not a proper date substring (perhaps a very unusual email address), and the associated email is sent conventionally without being retained.

The encoding of a date specifier can take a variety of formats. It is preferable that straightforward formatting be employed so that the sender can quickly dash off time specified email messages without referring to notes regarding the procedure, or the necessity of date encoding by application, although these mechanisms can certainly be utilized even with simple encoding structures. It should be appreciated that at the discretion of the retention organization (ISP in the instance of FIG. 1), the same email may be encoded with multiple delivery dates should the sender, for example, desire to post a reminder a week ahead of schedule and then post a follow-up the day prior to the event. This format allows, for instance, a dentist's office to post multiple, or progressive reminders with a single email that indicate to a patient the time for an upcoming scheduled appointment. If a patient fails to respond to the email, then notification can escalate to alternative, higher priority, messaging formats, such as the use of programmed telephone calls. Alternative message escalation formats are described further on within this specification. By way of example and not of limitation, Table 1 gives a few date/time formats which are preferred.

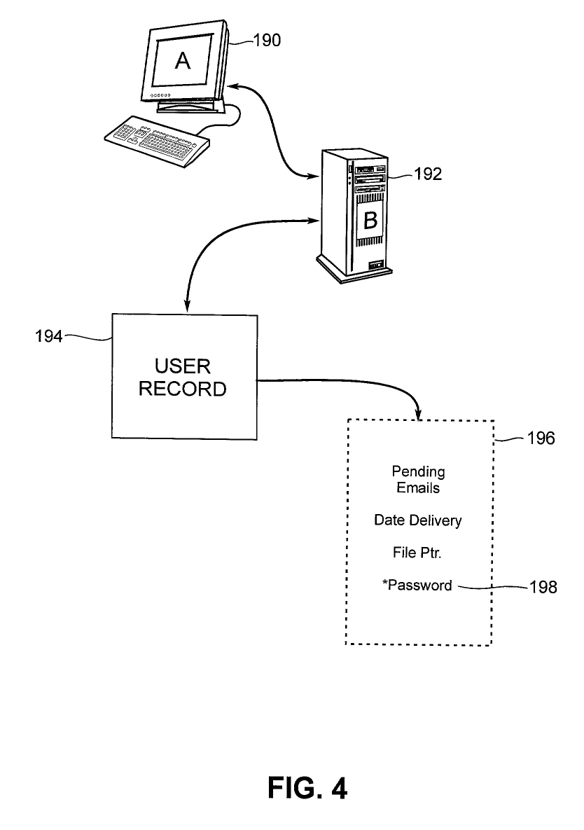

In addition, the user is preferably provided an editing and deletion capability by the message retention system. In the example of FIG. 1 utilizing a sender side ISP as the retention system, the sender logs into the website of the ISP and pursuant to entering a correct password can view a list of pending email messages which they have sent, and select these emails to perform actions upon, such as deletions, changing delivery time, and editing thereof. This capability is also available by sending an email with encoded control statements to the ISP. Although not directed primarily at manual senders, the capability allows various programmed schedulers to retract or alter prior pending email notifications. Referring back to FIG. 1, this control of emails waiting to be delivered 44 is shown by the dashed lines passing the email “e′” back from the ISP to the sender. By virtue of the relationship between ISP and sender, the ISP already contains information as to the sender and need only maintain an additional list of pending emails for each user as they are queued up to pend on the delivery date. FIG. 4 illustrates the system of the sender “A” 190 connected with the server “B” 192, such as the ISP of the sender which maintains a user record 194 for the sender that contains a pending delivery email list 196. As these are simplified flow diagrams, it will be appreciated by those of ordinary skill in the art that numerous “housekeeping” functions and relationships have not been described, for instance the ability to delete or change pending emails requires access between the user record and the pending list of emails ordered by delivery date, as changes on one list affect the other. Implementation and similar aspects of a database system are well known to those of ordinary skill in the art. Upon sending an email conventionally, it can not be withdrawn, by contrast, the present invention removes that restriction. At the discretion of the ISP, additional restrictions can be placed on the access of the email wherein the user would supply a password at the time the message is sent. This password can be supplied in various fields, for example a line at the top of the message body “#password=ducksandgeese” wherein the sender supplied password “ducksandgeese” will later be used to control access to the emails which are pending delivery. The password 198 is shown within the pending email list 196 which is accessible from the user record 194 relating to the original sender of the email.

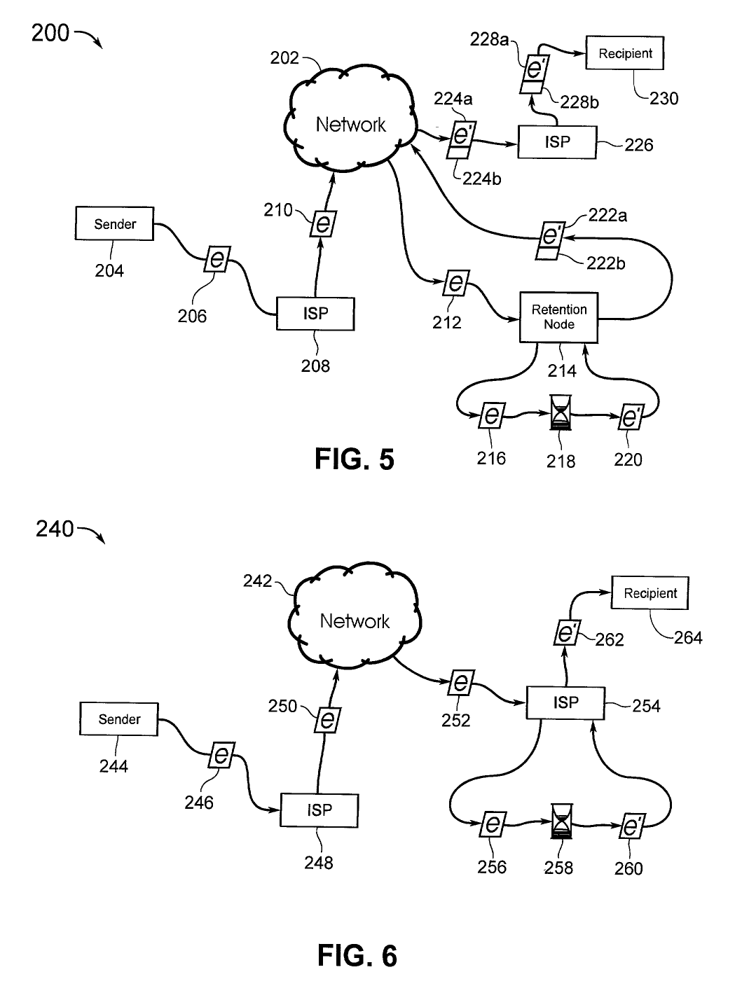

The system can be supported in various configurations and modes within the framework of the internet. An intermediate node retention mechanism 200 is illustrated in FIG. 5 wherein the intermediate retention node is connected to the internet 202 for receiving and retaining email messages prior to sending them on to their respective recipients. Any node on the internet, or alternative network supporting email, can be used as an intermediary for retaining the email messages for specified time delivery. In using an intermediary that is outside of the normal path from sender to recipient, the email must be addressed to reach the intermediary which then restores the correct recipient address and sends the email on its way when the specified delivery time has arrived. Various mechanisms were described for encoding an address field for an intermediary retention node. Following the process of specified time delivery in this case, a sender 204 creates/combines/assembles a message and sets the intermediate address as the “To” field and encodes one or more recipient addresses within the message, the user executes a send type command and the email message “e” 206 is sent. It should be recognized that an entire group list may be encoded within the message, preferably in the message header, wherein a single message can be sent to the intermediary which will then generate separate emails to the individual recipients. The email “e” 206 arrives at the ISP 208 which processes it as any other conventional email, and sends it immediately out toward the internet 210 with the destination set for the intermediary given by the “TO” field. After a typically circuitous trip over the internet, the email “e” 212 arrives at the server of the intermediary node 214. The server 214 interprets the coding of the specified time delivery and retains the email “e′” 216 within a mass storage system for a period of time 218. The server system of the intermediary checks the status of the retained emails periodically. When the specified delivery time for an email message arrives, the server pulls it from storage, extracts the intended recipient from the email and places it in the “TO” field creating message “e′” 220 which is then sent out by the server 214 as email “e′” 222a toward the internet. The server is shown having optionally appended content 222b, such as in the form of an advertising message onto the message being delivered to the recipient. The content may comprise any form of content viewable within or linked to an electronic message, including text, multimedia, graphics, sounds, files, and file pointers. It will be appreciated that the content additions are applicable to the other embodiments exemplified herein. Aside from the added content, the email at this stage appears conventional with no specially encoded fields and it passes through the internet and email “e′” 224a with added content 224b is received at the destination ISP server 226, which conventionally alerts the recipient 230 and thereafter passes the email “e′” 238a, 238b to the recipient according to standard protocols.

The system additionally provides for speeding up the transit time of emails after their respective delivery times have arrived, by establishing a distributed series of intermediaries, such as geographically intermediaries which are spread into different areas of the United States having domain names reflecting their position, such as state codes, or areas of the country, such as westcoast, eastcoast, central, and so forth. One intermediary could even take the emails and readdress and route them to a secondary intermediary node which would be located near the recipient. In general, performing the area routing requires that the original sender encode a coherent destination code within the message, such as “State =”.

FIG. 6 illustrates retention within a destination ISP server 240 over the internet 242. This configuration shares many aspects with the configuration of sender ISP retention, as the retention is performed in-line with the normal transit of the email. Although destination ISP retention has advantages, it will be appreciated that the recipient's ISP receives the burden of retaining the sender's email. A sender 244 creates/combines/assembles a message, specifies a delivery time, and executes a send type command wherein the email message “e′” 246 is sent to the server of the sender's ISP 248. The sender ISP 248 sends the email 250 conventionally toward the recipient via the internet 242. Emerging from the network (internet), the email message “e” 252 arrives at the destination ISP server 254. The destination server 254 detects the temporal parameter (date specification) and retains the message 256 on mass storage for a period of time 258. The server 254 periodically checks the queue of messages to be delivered and when the time arrives, retrieves the message “e′” 260 from mass storage, strips off the date specification within the email and notifies the recipient, later to pass the email “e′” 262 to the recipient 264. Utilizing differing encoding methods for the date can facilitate support for both sender and destination ISPs providing non-overlapping retention services.

The use of encoded fields within a standard email message and server software as described, can additionally provide enhanced email services. For instance, a user can have their emails formatted according to a predefined, or user defined, template. A phrase encoded within the message body such as “#Template=KissesToWife” would be extracted by either an ISP server or intermediary node and matched with a template or a multimedia pattern previously established by the sender. The sender can thereby access content to be linked or included with the email, without the necessity of editing the body of the message locally. For example, the user may have configured predefined HTML templates on a configuration page with the ISP, and can append, or link these elements of content to an email being sent. Currently, a sender can embed hypertext markup language within an email, however, the perceived complexity of entering direct commands beyond bolding and highlights within the email is a daunting prospect for many individuals, while special multimedia capabilities and effects can not be readily provided with a single HTML command. It should also be recognized that HTML effects are recipient browser dependent, as the emails are sent as HTML; wherein the encoding within the emails described herein are extracted by a node on the network (intermediary or ISP) which then may perform proprietary functions to modify the email with any collection of multimedia elements or markup elements in keeping with the encoded commands. It should be noted that the delimiter “#” is only used by way of example to show a method of speeding the search for valid command strings. Command parsing can be alternatively accomplished utilizing any form of strings and with or without a delimiter. Standardized multimedia patterns can also be retrieved according to encoded keywords. For example the encoded fields “#Event =”, “#Type =”, and “#Age =”, allow the specification of an event such as a birthday along with subevent modifiers which allows the user to select the type of multimedia to be put with the email. For simpler email additions the user can specify what to send to the recipient, for instance an encoded email field such as “Send=roses” or for more “Send=12 roses”. In all of these cases, the sender is saved the onerous and time-consuming task of logging on to a site to compose and send each email. Web sites that provide content to web visitors can in addition provide retention services as intermediaries as per the present invention, wherein the sender accesses cards or email message templates they have set up within the web site, and gain that access to emblazon a card without having to visit the web site. In order to pay for the service the intermediary sites may add a small commercial message, or link, to a portion (preferably the bottom) or portions of the email message being passed along.

The parsing of command strings is well known in the art and the flowchart of FIG. 3 is similar to that which would be required for the command strings. In extracting command strings, it is preferable that a series of commands be extracted and a list of function pointers or tokens created such that message formatting is performed only after all the commands have been extracted. By way of example and not of limitation, Table 2 provides examples of preferred commands.

A compelling use for enhanced email services is in cross-media communication services. It is generally recognized that each form of communication has a cost factor and a “nuisance” factor; generally an email is the least cost and nuisance factor, while telephone calls, being synchronous events have the highest nuisance factor. Unfortunately, an email is the easiest form of message to miss or ignore, therefore improved communication efficiency can be derived by using reminders of the lowest level which can escalate or morph to other communication forms if no response is received. It will be appreciated that cross-media communication services are well suited for use by sender side ISPs and servers, since the extended features are being performed for a known user, such that an ability to charge the user for the extended capability is available to provide additional revenue, and usage abuses can be prevented. This cross-media communication ability can simplify the posting of appointment reminders, self-reminders, reminders to group lists of meeting attendees. By way of example and not of limitation Table 3 provides examples of preferred enhanced communication commands.

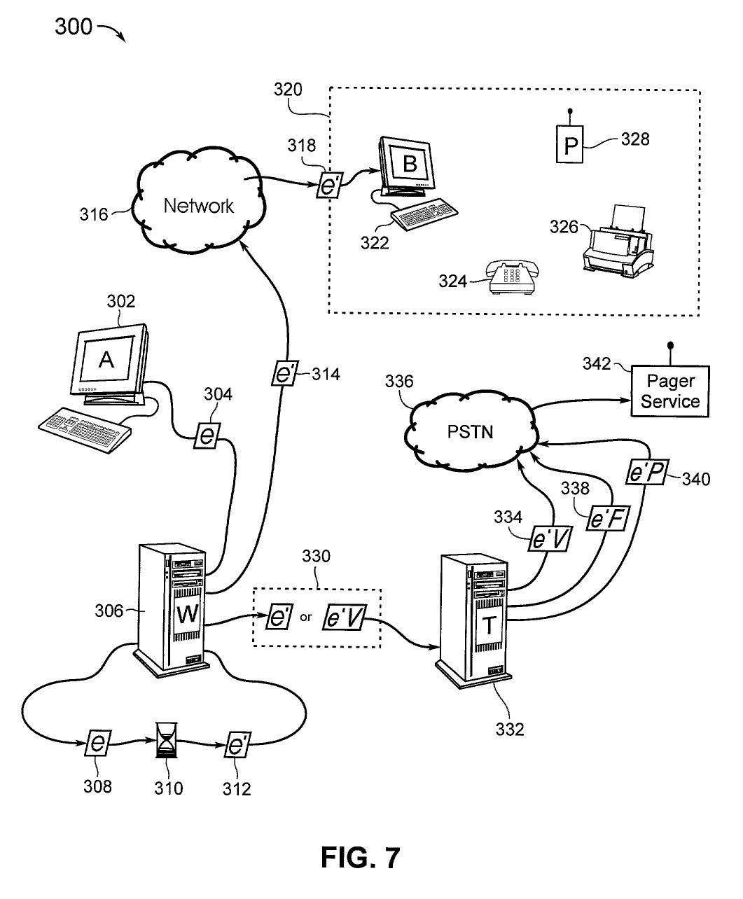

FIG. 7 exemplifies the use of this reminder escalation 300 by way of the enhanced specified time delivery emails. A user desires to notify one or more individuals of a meeting, appointment, or other event planned for the morning of Sep. 28, 2000. They compose an email message on station “A” 302 which by way of instantiating a single example, include the following lines in the message body:

#Template=10Memo

#Date=090200 #Note=Schedule it today

#Date=092600 #Note=REMINDER, Don't forget

#REPLY=weaselmaster

#NRFAX=092700at0930AM, 555-1214

#NRPager=092700at0330PM, 555-1213, text, 12345

#NRCall=092700at0800PM, 555-7388

: : : : : :

. . . Remainder of Message Body

The message fields note that the Interoffice Memo template is to be used for the message and that it is to be sent as an email on September 2nd with a note appended to the top of the message body stating “Schedule it today”. A second reminder is to be sent by email on September 26^{th} with the note “REMINDER, Don't forget” and a Reply code field within the message set for “weaselmaster” and a note which requests a reply from the recipient is preferably automatically appended. The #REPLY field following a #Date field indicates that a reply to the sent item is required and the text or numbers following are any values desired to identify that the returning reply is associated with this message. Alternatively, reply codes can be automatically and seriptitiously embedded within an email which are set according to a specific “#Date =” instance so that reply, containing the message body and hidden reply code, is verified. It should be appreciated that numerous synchronization mechanisms exist capable of matching a reply with an original email. Returning now to the example: if no response reply is received with the reply code “weaselmaster” from this second notice by the 27^{th} at 9:30 AM then the message is to be sent as a FAX to 555-1214. The FAX will include an email address and response code “weaselmaster” so that the FAX receiver can acknowledge by email (if they have lost the original FAX already sent). If still no acknowledgement has been received by 3:30 PM on the 27^{th}, then the pager (a text pager) will be called at 555-1213 with for instance a pager code 12345, wherein the message is sent as text as the pager is an alpha-compatible pager capable of receiving email text. If still no acknowledgement has been received by the night before the event (27^{th} at 8:00 PM) then a telephone call is made to 555-7388 (perhaps the parties home phone) and the email is played out, such as in a synthesized voice. Acknowledgement can be collected from a voice response and directed back by the FAX/Telephone server and configured as a reply.

In reference to the previous discussion and FIG. 7, the email 304 containing the enhanced codes is received by the ISP web server “V′” 306 which stores it 308 in mass storage for a period of time 310 until the delivery time arrives when it is removed as “e′” 312 and operated upon by the web server “W′” 306. Upon the first date the email “e′” 314 is sent via a network 316 to arrive as email 318 for the recipient. The recipient has communications equipment 320 at his/her premises which include a network enabled computer, server, station, device, or appliance capable of receiving email 322, a phone 324, a FAX 326, and a Pager 328. The system can also access multiple phone numbers as well as cellular phones and even generate and send email through conventional physical mail, or courier, services if appropriate. The first notice, however, is shown being received on the computer 322. A reply to this first message does not contain the #REPLY field “weaselmaster” and therefore cannot reset the state of reply to prevent the subsequent reminders. After sending the first reminder, the email message having not fulfilled all listed reminder sending is retained again 308 in mass storage, preferably sans the first “#Date =” line that has been fulfilled, and put into storage 310. The second reminder is taken from storage as email message 312 “e′” and sent as email “e′” 314 on the 26^{th}, it requires that the user reply. Assuming that a correct user reply is received as email within the server 306 which checks for reply code “weaselmaster”, in this case. Having found a reply, the corresponding original email is checked, since no other replies need to be fulfilled within the email, the email has been completed and is not resaved, however, the reply is still forwarded to the sender. Should no reply be forthcoming, the reminder notifications continue. At the time of the third reminder on the 27^{th} at 9:30 AM, the email 312 is pulled from storage into the web server 306, formatted by software and passed to the FAX/telephone server “T” 332 over the network within the ISP. Various FAX/Telephone servers exist today which are capable of sending FAX and or voice messages from text based data. It should be noted that many telephone systems and voice mail systems offer FAX/Telephone server capabilities as well. The FAX/Telephone server 332 sends a FAX page rendition 338 of the email message over the public switched telephone network (PSTN) to the recipient's FAX machine 326 which reminds the recipient of the event and that a reply is required. Should the recipient still not respond, reminders continue and on the 27^{th} at 3:30 PM the email message 312 is pulled up from storage into the web server 306 and formatted for the telephone pager. Various types of pagers exist, some can receive email type message, some short voice message, while other still only receive the callers phone number. The pager message for example may be formatted for a text pager wherein the FAX/Telephone server 332 generates a call “e′P” 340 which passes the text through the PSTN to a pager service 342 which sends a radio signal to pager 328 of the recipient which thereby receives the reminder message. If the recipient does not respond to the pager notification reminder, then reminders continue to escalate, on the 27^{th} at 8:00 PM the email message 312 is pulled up from storage again into the web server 306 and a voice message is generated from the text of the email message. The voice message “e′V” is passed to the FAX/Telephone server 332 which generates a call “e′V” 334 which passes the voice message through the PSTN to the telephone 324 of the recipient. The FAX/Telephone server is preferably set to continue sending the message until it is picked up by a live party responding to the message or an answering machine.

It can be easily recognized that the use of enhanced email message notices with the specified delivery as taught by the invention and exemplified above can provide functionality which facilitates the organizing of parties and groups while reducing the cost of these notifications. It will also be recognized by anyone of ordinary skill in the art that an infinite variety of system configurations, embodiments, and protocols can be arrived at from the inventive teachings without the need of creative effort.

The various descriptions so far have taught the use of the sender coding for the various date and command strings within the email message for generating the specified delivery emails, however, the mechanism is ideally suited to allow software programs to embed the strings within the email. For example any email composition program can integrate specified delivery email functionality within their software to simplify the task of creating complex reminders. The composition screen may provide screen fields for delivery date and time entry which can be filled out by the user, as well as the support of the aforementioned enhanced functions. In addition, since many composition programs have access to address books, the sender need not supply the various numbers, such as telephone number, for the recipient as they may be pulled up automatically. Furthermore, group list addresses can allow message to be easily sent to group lists at the selected delivery time. Also, if the system has a connection that is not always connected (such as the common dial-up connection) and the email is not to be delivered for a long time period, then the composition program can give the user the option to send upon next connection. Wherein the composer can hold the email without initializing a connection, thereby saving the user time in establishing a connection for the sole use of communicating the future delivery electronic message. Therefore, when a connection is next established the email is sent. The email is then timely delivered by the email retention means (ISP or intermediate node) as described earlier. Still further the specified time delivery and reminders can be used by application software, such as office automation systems for Doctor's offices, so that the burden of reminders are simplified. As the majority of phone companies provide internet services, the integration of email with telecommunication services via the PSTN, or other telecom infrastructure, is a natural cross-over application. It should be appreciated that the alternate embodiments utilizing storage at an intermediary node or recipient ISP node are also compatible with the functioning of the enhanced email commands such as the above reminder message escalation.

The systems and methods according to the present invention are therefore capable of delivering electronic messages at a predetermined time, or delay, and may be implemented such that the message retention function may be performed at various locations within the network infrastructure. Furthermore, enhanced features are provided that allow for linking additional content into the temporally displaced emails, and for the escalation of messages under user control. It will be appreciated that these aspects of the invention may be utilized in combination or separately, and may be integrated within various applications, or equipment without departing from the present invention. One of ordinary skill in the art will also appreciate that the implementation structures, commands, and keyword were provided by way of example and may be diversely implemented without departing from the present invention.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Examples of Date/Time Formats

| | |
|---|---|
| mmddyy | standard month day year format |
| mmddyyathhmm | month day year at the hours and minutes specified |
| | (relative to senders timezone) |
| mmddyyathhmmEST | above specifier time given as Eastern Standard |
| ddMMMMyyyy | day, month text, year i.e. 02SEPT2000 |
| delaynndays | offset from the present date by nn days |
| delaynnhours | offset from present time by nn hours |
| onHolidayText | i.e. onNewYears, onChristmas, onValentinesDay |

TABLE 2
Examples of Enhanced email Commands

| | |
|---|---|
| #Date = | Can specify additional reminder date |
| #State = | for use when msg distributed to secondary intermediary |
| | nodes which are geographically near the recipient |
| #Send = | allows sending of common multimedia elements |
| #Template = | use the predefined template to format the email |
| #Event = | set an event type to which the email is to accord |
| #Type = | type of media or characterization |
| #Age = | age that additions are to be directed at |
| #Style = | set a style for the email: i.e. classy, colonial, hick |
| #Group = | To select a group list for email sending |
| #Background = | use item, or given color as a background to the email |
| #TextColor = | set text color |

TABLE 3
Examples of Enhanced email Communication Commands

| | |
|---|---|
| #Date = | as described previously, but each date can have #Note, |
| | #REPLY and other commands associated with it |
| #Note = | Associated with a particular instance of the #Date |
| | command |
| #REPLY = | assert a reply code to associate with a #Date for automatic |
| | cancellation of the escalation. |
| #FAX = | specification of date, time and number to be FAXed, users |
| | often want multiple send types. (Also user may not have |
| | email such that a fictitious destination entered with this |
| | code provides a FAX conversion gateway) |
| #Call = | specification of date, time, and number to be called. Users |
| | often want multiple send types, whereas the system allows |
| | voice data to be generated, for instance by synthesis |
| | software, from the email text and the call generated at |
| | send time. |
| #Pager = | specification of date, time, and number to be called, type of |
| | pager, and other info such as pager code. Same as for |
| | FAX and Call. Various pager types (text, limited voice, and |
| | standard are supported) |
| #NRFAX = | similar to #FAX, but generates a FAX ONLY if no reply is |
| | received to the prior REPLY command. |
| #NRPager = | Pager call generated only if no reply code received |
| #NRCall = | Telephone call generated only if no reply code received |

What is claimed is:

1. A system for sending temporally displaced electronic messages over a network, comprising:
(a) a sending system capable of accessing a network and configured to encode a temporal specifier into an electronic message to be sent over said network to a recipient at a destination address on the network; and
(b) a retention system connected on said network, configured to decode the temporal specifier of said electronic message, store said electronic message, and send said electronic message to the destination in accord with the specified temporal specifier.

2. A system as recited in claim 1, wherein the sending system comprises a first computer capable of executing programmed instructions.

3. A system as recited in claim 1, wherein the retention system comprises a second computer connected to a network and capable of executing programmed instructions.

4. A system as recited in claim 1, wherein the internet service provider (ISP) for the sending system comprises the retention system such that electronic messages sent from the sending system must pass through the retention system associated with the ISP.

5. A system as recited in claim 1, wherein the internet service provider (ISP) for the recipient at the destination address comprises the retention system such that electronic messages sent from the sending system must first pass through the retention system associated with the ISP of the destination address prior to arrival at the destination.

6. A system as recited in claim 1, wherein the sending system further encodes the network address of the retention system into the electronic message, such that the electronic message containing the encoded temporal specifier is first sent to said retention system prior to said retention system sending the electronic message to the recipient at the destination at a time according to the temporal specifier.

7. A system as recited in claim 1, wherein the retention system is capable of adding content to the electronic message.

8. A system as recited in claim 7, wherein the content added by the retention system is selected from sources of content consisting of text, multimedia, graphics, sounds, files, and file pointers.

9. A system as recited in claim 1, wherein the sending system is configured to encode commands for escalating the communication of the body of the electronic message to the recipient, and wherein the retention system is responsive to these escalation commands to communicate the body of the electronic message to the destination address additional times.

10. A system as recited in claim 1, wherein the body of the electronic message is communicated additional times through a communication media in a format selected from the group of media formats consisting of electronic messages, telephone messages, FAX messages, and Pager messages.

11. A method of sending electronic messages over a network which are to be delivered to a recipient at a destination address at a predetermined later time, comprising the steps of:
encoding a sender specified time coordinate within an electronic message;
sending said electronic message for delivery over the network to a recipient at a destination address;
receiving said electronic message for processing within a retention system;
extracting the time coordinate from the electronic message;
retaining the electronic message until the specified time coordinate arrives; and
sending the electronic message to the destination address.

12. A method as recited in claim 11, wherein the retention system comprises a mail server provided by the internet service provider of the sender.

13. A method as recited in claim 11, wherein the retention system comprises a mail server provided by the internet service provider of the recipient at the destination address.

14. A method as recited in claim 11, wherein the user specified delivery time coordinate is configured to be equated to a particular day.

15. A method as recited in claim 11, wherein the user specified delivery time coordinate is configured to be equated to a particular day and time.

16. A method as recited in claim 11, wherein the retention system provides editing and deletion capability on the retained electronic messages to the sender of the electronic messages.
